(19) United States
(12) Patent Application Publication
(10) Pub. No.: US 2007/0194906 A1
(43) Pub. Date: Aug. 23, 2007

(54) ALL HAZARD RESIDENTIAL WARNING SYSTEM

(75) Inventor: Gregory A. Sink, Frankfort, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Federal Signal Corporation, Oakbrook, IL (US)

(21) Appl. No.: 11/558,802

(22) Filed: Nov. 10, 2006

Related U.S. Application Data
(60) Provisional application No. 60/775,634, filed on Feb. 22, 2006.

(51) Int. Cl. G08B 29/00

(52) U.S. Cl. 340/506

(57) ABSTRACT

A networked system of addressable alarms notifies citizens of conditions within a community, A control center is communicably linked via the network to alarm devices such as smoke detectors in controlled environments such as buildings in order to alert citizens of conditions outside of the controlled environment, which may be situations requiring an emergency response. The alarm devices may also be capable of sending local status information (e.g., fire alarms, security alarms, etc.) to the control center so that the control center can respond as necessary to any local emergencies.

### CROSS-REFERENCE TO RELATED APPLICATIONS

This patent application claims the benefit of U.S. Provisional Patent Application No. 60/775,634, filed Feb. 22, 2006, which is hereby incorporated by reference in its entirety.

### BACKGROUND OF THE INVENTION

Many governmental and non-governmental agencies are responsible to citizens to detect man-made and natural emergencies and warn the citizens of any dangers they present. When situations require citizens be immediately warned, the warnings are typically transmitted through television and radio broadcasts and by wide-area public address systems such as a network of outdoor warning sirens located throughout a community. For example, in the United States, the National Weather Service broadcasts tornado warnings to communities in the tornado's path by interrupting the commercial broadcasts of local radio and television stations. However, not all people in the targeted communities may be listening to local radio or television.

Also, many people in the zone of danger may be located outside the audible range of any network of outdoor warning sirens. Others may be in controlled environments in which the outdoor sirens are not heard for a variety of reasons. Such controlled environments are for example buildings that are well insulated, located at the fringe of the effective range of the outdoor warning sirens and audio sourcing from within the controlled environment dilutes the effectiveness of the outdoor warning siren.

Additionally, the granularity of broadcast radio and television warnings warn everyone in a large area that often has a low correlation to the area that is in present danger. As a result, citizens may over time tend to ignore these warnings if they view them as more often then not aimed at others. As a result, existing warning systems could be improved if they could be targeted to precisely warn those citizens that are deemed to be in danger. Outdoor warning sirens in a community warning system may be individually addressable to provide some amount of granularity, but they nevertheless still depend on their ability to penetrate controlled environments such as buildings that may be insulated for both temperature and noise.

The National Oceanic and Atmospheric Administration (NOAA) of the United States Federal Government, working with the Federal Communication Commission's (FCC) Emergency Alert System, provides an “All Hazards” radio network (commonly called “NWR”) for the United States for weather and emergency information. NWR includes more than 940 transmitters, covering all 50 states. NWR requires a special radio receiver or scanner capable of picking up the signal. NWR broadcasts over the VHF public service band at the following seven frequencies (MHz): 162.400, 162.425, 162.450, 162.475, 162.500, 162.525 and 162.550.

NWR has the capability of sending Emergency Alert System (EAS) event codes using Specific Area Messaging Encoding (SAME). Using the SAME format, civil emergency, weather, and natural event codes can be issued through 940 transmitters that cover most of the United States. The smallest geographical area the NWR targets is one ninth of a county using Federal Information Processing Standards (FIPS) codes that essentially divide the United States into unique geographical areas by states and counties.

Although NWR has the ability to limit its broadcast signal to receivers associated with selected FIPS codes, the codes nevertheless cover wide areas (e.g., one ninth of a county) and are likely to be over inclusive with respect to a local emergency, which gives rise to the same problems of alerts issued over commercial broadcasts. Also, NWR's service to a specific area defined by the FIPS codes depends on reliable signal reception, which typically extends to about a 40-mile radius from the NWR transmitter, assuming level terrain. Some counties or parts of counties, especially in mountainous areas, may have unreliable reception due to signal blockages or excessive distance from the transmitter. Like the use of commercial broadcasts, the NWR system depends on the receivers being turned on and tuned to the appropriate frequency.

### BRIEF SUMMARY OF THE INVENTION

One or more alarms are equipped with an addressable receiver that triggers the alarms within controlled environments in order to alert and warn any occupants of the environments of an emergency condition outside of the controlled environments. In one embodiment, the alarms are smoke detectors equipped with receivers. The receiver is associated with a unique address and responds to reception of the address by triggering the one or more associated alarms. Preferably, the receivers are physically associated with the alarms. The alarm and the receiver may be in a single package or the receiver may be mechanically interfaced to the alarm. In this regard, one of the embodiments of the alarm may be a smoke detector that incorporates the addressable receiver. Alternatively, a convention smoke detector may be retrofitted with the receiver by way of an electromechanical interface.

The alarms are in communication with a control center by way of a community-wide network such as, for example, a wireless network such as a Wi-Fi mesh network deployed over a community served by the control center. When the warning device is a smoke detector, the receiver may be incorporated into a transceiver so that the smoke detected in the controlled environment can be communicated back to the control center in order to enable the control center to coordinate the quick deployment of first responder resources. For example, the address of the smoke detector may be correlated to locations within the community served by the control center and receipt of the address from the smoke detector transmitter is quickly converted to an address that can be the destination for the dispatched first responders.

In one embodiment, the control center is an emergency operation center such as that described in U.S. patent application Ser. No. 11/505,642, filed Aug. 17, 2006, and entitled “Integrated Municipal Management Console.” In this embodiment, the control center is linked to other portions of the management system, including a number of data sources. In this regard, the control center receives information from a variety of sources that provide information that the control center processes to determine if a dangerous condition exists. For example, the management system may include a weather station as one of the data sources. When the weather station detects a severe or dangerous weather condition, information describing the weather condition is received at the control center, processed and then sent to selected smoke detectors as determined by their network addresses.

Alarms equipped to receive warning signals from the control center may be dedicated devices or multifunctional. When the alarms are multifunctional, the warning signals they generate may be different for each type of warning in order to differentiate different emergency situations. For example, when the alarm is a smoke detector, it preferably responds to the control center with a warning signal different from the warning signal when the smoke detector is triggered by ambient smoke. In this regard, the trigger from the control center may be a warning of dangerous local weather whereas the trigger from the ambient smoke is obviously warning of a local fire. By providing different warnings for these two conditions, the smoke detector warns those in the controlled environment of the smoke detector of both fire and dangerous weather and differentiates between the two. In general, the alarm can be responsive to as many conditions as it can provide different warning signals. For example, the alarm may incorporate a local security system. In the case of the smoke detector, it may be interfaced to the security system in a conventional manner to communicate to a proprietary security assurance entity. However, the same or a different interface may also send security warnings back out through the network to which the smoke detector is connected and thereby enable the control center to also respond to a security warning.

In one embodiment, the alarm is a conventional device such as a smoke detector that mates with an adapter in order to enable it to communicate over the network with the control center. In another embodiment, the alarm is a dedicated device such as a smoke detector equipped with the necessary electronics for communicating with the control center. In either case, when the alarm is a smoke detector, the warning signals may be provided by a common enunciator such as a buzzer. To differentiate among different warnings, the signal may simply provide different patterns such as a series of sustained tones for a weather warning from the control center and a series of short tones for smoke. In general, the differences in the warning signals should be easily detectable to the human ear. Because the network may be a broadband network, the warning may even be in the form of a voice message originating from the control center or even a message that includes video if the receiving alarm is equipped to process such data types.

The alarm and control center are nodes in a network, The network may be of several different types such as a Wi-Fi network, a Wi-Max network, wireless mesh networks or cellular networks and may comprise combinations of wired and wireless technology. The network may even cooperate with other networks to communicate information. For example, a smoke detector may be connected to the control center thru a gateway connecting a local area network (LAN) to the network hosting the control center either directly or through another gateway. In one embodiment, a Wi-Fi enabled smoke detector communicates with a LAN such as a wireless home computer network. The LAN connects to a local gateway, such as a personal computer or router. The local gateway provides access to a wide area network, such as the Internet. With the control center also connected to the wide area network, the smoke detector is able to communicate with the control center by sending and receiving signals from the wide area network via the gateway. Regardless of the precise composition of the network, the communications protocol employed by the network supports addressing the network nodes such that the control center can communicate with individual ones of the alarms.

The alarm system according to various embodiments incorporates other features and advantages that will be more fully appreciated from the following description in conjunction with the accompanying figures.

### BRIEF DESCRIPTION OF THE SEVERAL VIEWS OF THE DRAWINGS

FIG. 1 is a wireless wide-area network that provides a communications environment for the illustrated embodiments of an alarm system;

FIG. 2 illustrates local and community wide alarms that complement one another to provide an overall emergency signaling system that incorporates the wireless wide area network of FIG. 1;

FIG. 3 illustrates an embodiment of the wireless wide area network comprising a wireless mesh network, which includes transceivers associated with the local alarms in buildings;

FIG. 4A illustrates another embodiment of the wireless wide area network comprising a point-to-multipoint system;

FIG. 4B illustrates still another embodiment of the wireless wide area network comprising a combination of a point-to-multipoint system and a mesh network;

FIG. 5 is an outdoor warning siren that includes a transceiver such as a Wi-Fi transceiver that serves as a node in the mesh network illustrated in FIG. 3;

FIG. 6 illustrates yet another embodiment of the wireless wide area network comprising a cellular network;

FIG. 7 is a schematic diagram of a Wi-Fi enabled smoke detector, which is an example of the local alarm in the illustrations of FIGS. 2-4 and 6;

FIG. 8 is a block diagram of a suitable Wi-Fi transceiver for the smoke detector of FIG. 7;

FIG. 9 is a diagram illustrating the flow of information from a control center such as illustrated in FIGS. 2-4 and 6 to the Wi-Fi enabled smoke detector of FIGS. 7 and 8;

FIG. 10 is a diagram illustrating the flow of information from a local alarm to the control center in response to an activation signal such as a local smoke or carbon dioxide sensor;

FIG. 11 is a diagram illustrating the format of an exemplary alarm signal communicated to the control center;

FIG. 12 illustrates a Wi-Fi enabled adapter that interfaces with a conventional smoke detector in order to integrate the conventional detector into a community-wide emergency system; and

FIG. 13 is an embodiment of a database at the control center of FIGS. 2-4 and 6 that enables the control center to resolve locations of alarm devices that are both stationary and mobile.

### DETAILED DESCRIPTION OF THE INVENTION

The following description is intended to convey the operation of exemplary embodiments of the invention to those skilled in the art. It will be appreciated that this description is intended to aid the reader, not to limit the invention. As such, references to a feature or aspect of the invention are intended to describe a feature or aspect of an embodiment of the invention, not to imply that every embodiment of the invention must have the described characteristic.

Agencies, such as the United States National Weather Service, monitor communities through the use of satellite systems in order to determine if a disaster is imminent or has just occurred. For example the National Weather Service may determine that a tornado is threatening an area and send out a warning that is received by local authorities or citizens. The local authorities then make the decision whether to warn citizens of the danger by sounding a community siren and/or interrupt commercial broadcast serves such as radio and television.

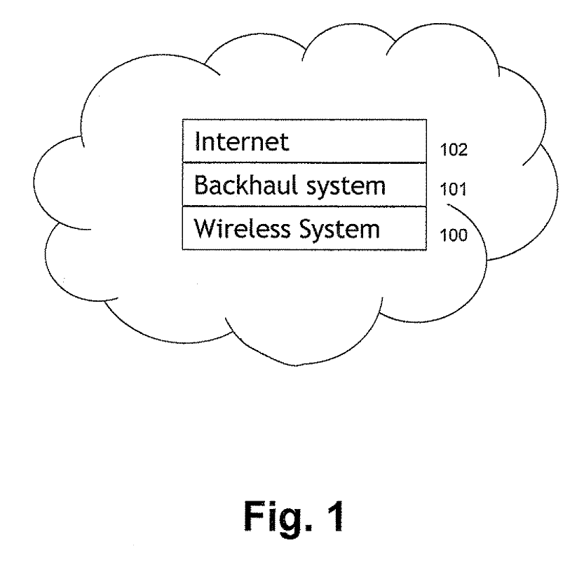

Adding a small networking adapter to an alarm, such as a smoke detector, turns it into an all hazard warning device that is activated through a warning network system such as the wireless wide area network of FIG. 1. The wide area wireless network includes a wireless system 100 connected to a backhaul system 101 that connects the wireless system 100 to the Internet 102. The wireless system 100 sends and receives messages and signals from the Internet 102 thru the backhaul 101. Alternatively, the signals can be sent and received directly thru the backhaul 101 and not rely on the Internet 102.

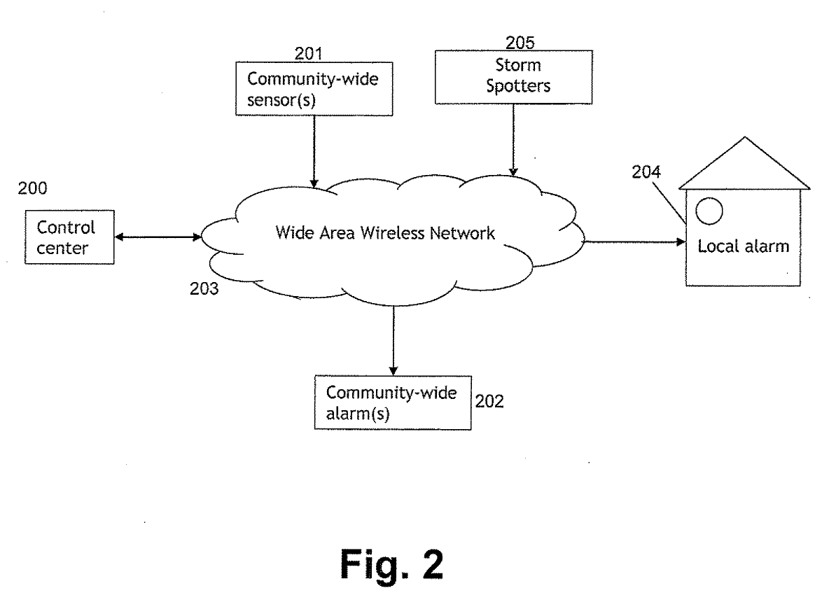

Referring to FIG. 2, an emergency manager located at a control center 200 detects an emergency via information received from either distributed sensors such as community-wide sensors 201 or human observation such as storm spotters 205. In response to the detection of the emergency, the manager activates community wide sirens 202. The warning sirens 202 are activated via a two-way radio directly from the control center 200 (not illustrated) or thru the network 203. An alarm 204 in a control environment such as a commercial or residential building receives a signal thru the network 203 or two-way radio and turns on with a pulsing sound, which distinguishes it from a traditional steady alarm so a listener knows it was activated by the emergency control center. The alarm 204 can be programmed to automatically play any number of tones and pre-recorded messages, depending on the source of the triggering signal. Finally, the alarm 204 can be configured to broadcast messages received through the network, thereby providing citizens with pertinent real-time information regarding the disaster.

Since the alarm 204 is network enabled, it can also send a signal thru the network 203 to the emergency operation center 200 when the alarm is activated in response to the local detection of an emergency condition such as smoke or a high level of carbon monoxide, enabling the appropriate first responder such as the fire department or ambulance to be dispatched to the location by the control center 200.

The control center 200 can take various forms, including the control center described in co-pending U.S. patent application Ser. No. 11/505,642, filed Aug. 17, 2006, entitled “Integrated Municipal Management Console,” which is hereby incorporated by reference in its entirety and for everything that it describes. In the United States, other embodiments of the control center 200 include a community's Emergency Operation Center (EOC), the National Weather Service or any other appropriate central management system for enabling emergency responses. In this regard, activation of the alarm 204 may complement the activation of other warning devices connected to the control center 200 such as the local community warning sirens.

The alarm 204 includes virtually any network capable device that can be configured to receive information from the control center 200. Examples of the alarm are carbon monoxide detectors, clock radios, or any other device capable of broadcasting a message within its controlled environment that can be sensed by occupants of the environment. The alarm 204 can be either a device that incorporates network capabilities or it can be retrofitted with a network adapter. In either case, it can be programmed to broadcast tones or messages in response to an alert issued by an agency. Additionally, some alarms 204 may be mobile and equipped to provide location information to the control center 200. The central control tracks the present location of the alarm in order to enable the control center to trigger only those mobile alarms in the vicinity of an emergency condition.

The messages from the control center 200 to the alarm 204 may include text suitable for displaying on a display at the alarm 204. Such alarms 204 display the alert message with or without a complementing audible tone or message. If an alarm 204 is configured for two-way communication, it can send emergency or informational data to the control center 200 or other alarm node in the network.

A large number of configurations are suitable for the wide area network 203. Wired, wireless or a combination of wired and wireless systems may comprise the wide area network 203. In one embodiment, the alarm 204 is a smoke detector with Wi-Fi capability. Wi-Fi is shorthand for wireless fidelity and generally refers to any type of 802.11 network, whether it is 802.11a, 802.11b, 802.11g or 802.11n. The term is promulgated by the Wi-Fi Alliance. The 802.11 designation refers to a family of specifications developed by the Institute of Electrical and Electronic Engineers (IEEE) for wireless communication technology. The 802.11 specifications define an over-the-air interface between a wireless client such as the alarm 204 and a base station such as the control center 200 or between two wireless clients such as two alarms 204. Products that are tested and approved as “Wi-Fi Certified”® by the Wi-Fi Alliance are known to interoperate with each other, even if they are from different manufacturers. Currently the following 802.11 specifications exist:

| Standard | Type | Speed | | Frequency | Encoding Scheme |
|---|---|---|---|---|---|
| 802.11 | Wireless LANs | 1 or 2 | Mbps | 2.4 GHz | Frequency Hopping Spread Spectrum (FHSS) |
| | | | | | Direct Sequence Spread Spectrum (DSSS) |
| 802.11a | Wireless LANs | 54 | Mbps | 5.0 GHz | Orthogonal Frequency Division Multiplexing (OFDM) |
| 802.11b | Wi-Fi | 11 | Mbps | 2.4 GHz | (DSSS) |
| 802.11g | Wireless LANs | 20+ | Mbps | 2.4 GHz | (OFDM) |
| 802.11n | Wireless LANs | 540 | Mbps | 2.4 GHz | Multiple-input multiple-output (MIMO) |
| | | | | | Not yet ratified by the IEEE |

Today many communities are implementing city wide and/or county wide Wi-Fi systems that allow the transmission and reception of many data types such as voice over Internet protocol (VoIP) and video. Wi-Fi systems also may allow access to the Internet. Devices connected on these systems typically have unique Internet Protocol (IP) addresses and unique media access control (MAC) addresses.

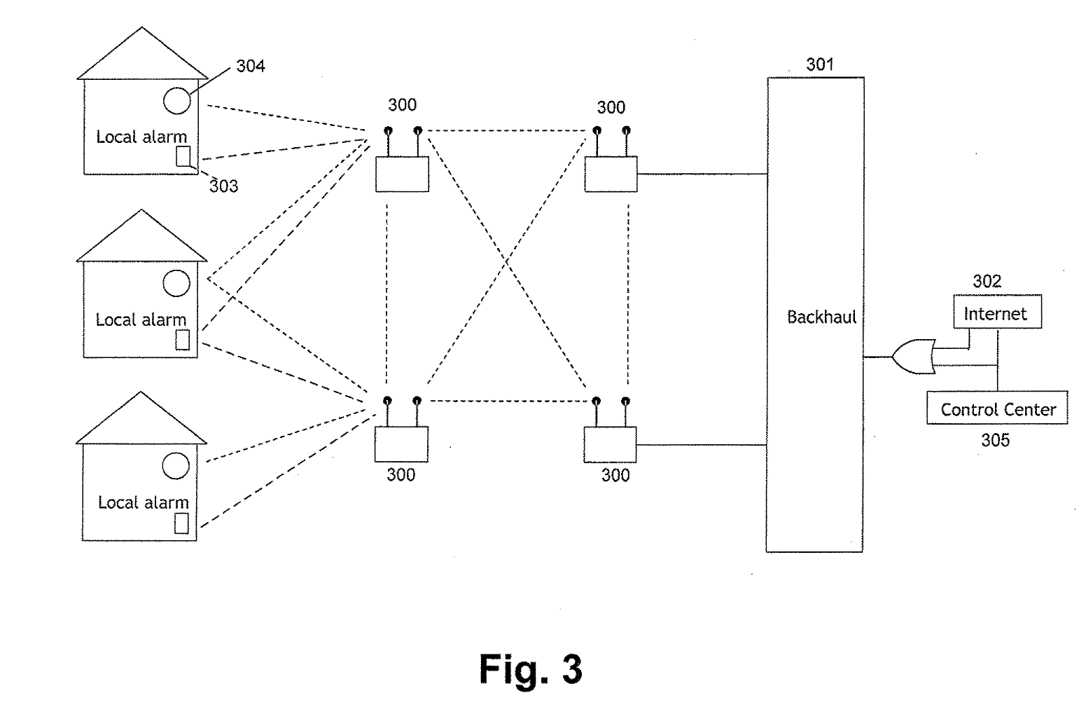

Any appropriate configuration and protocol can be used for the community network. For example, FIG. 3 illustrates a wireless mesh network that a community can implement using Wi-Fi. Towers 300 act as nodes within the mesh network, routing data as needed among themselves and to the backhaul system 301 for connection to the Internet 302. Various devices with Wi-Fi capabilities connect wirelessly to the mesh network thru the towers 300. For example a computer 303 located within a home connects via Wi-Fi to the towers 300 comprising the mesh network. Packets of data are transmitted from the computer 303 to the towers 300, thru the backhaul 301 to the Internet 302.

In the illustrated embodiment, a smoke detector 304 configured with a Wi-Fi adapter connects directly to a wide area mesh Wi-Fi network. The smoke detector 304 sends and receives messages thru the mesh network by connecting to any of the towers 300. When a conventional smoke detector is configured with a Wi-Fi radio transceiver operating in accordance with the 802.11 specification and it is in the presence of a wireless system installed in a municipality, the smoke detector can be controlled by a control center 305. The control center 305 sends a signal thru the Internet 302 in response to an event. The message is forwarded thru the backhaul 301 and then over the municipal network thru the towers 300. The smoke detector 304 receives the message by connecting to any tower 300. The smoke detector emits a pulsing sound to notify occupants of the building that the control center issued a warning. The control center 305 may also connect directly to the backhaul 301 or may connect to any other appropriate network.

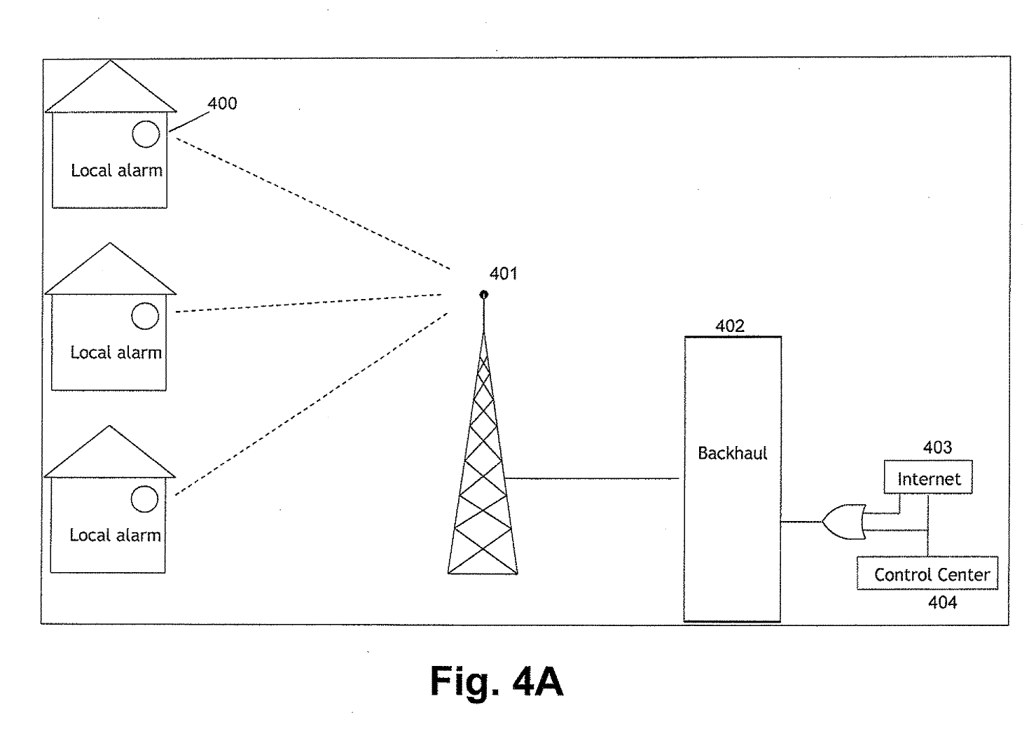

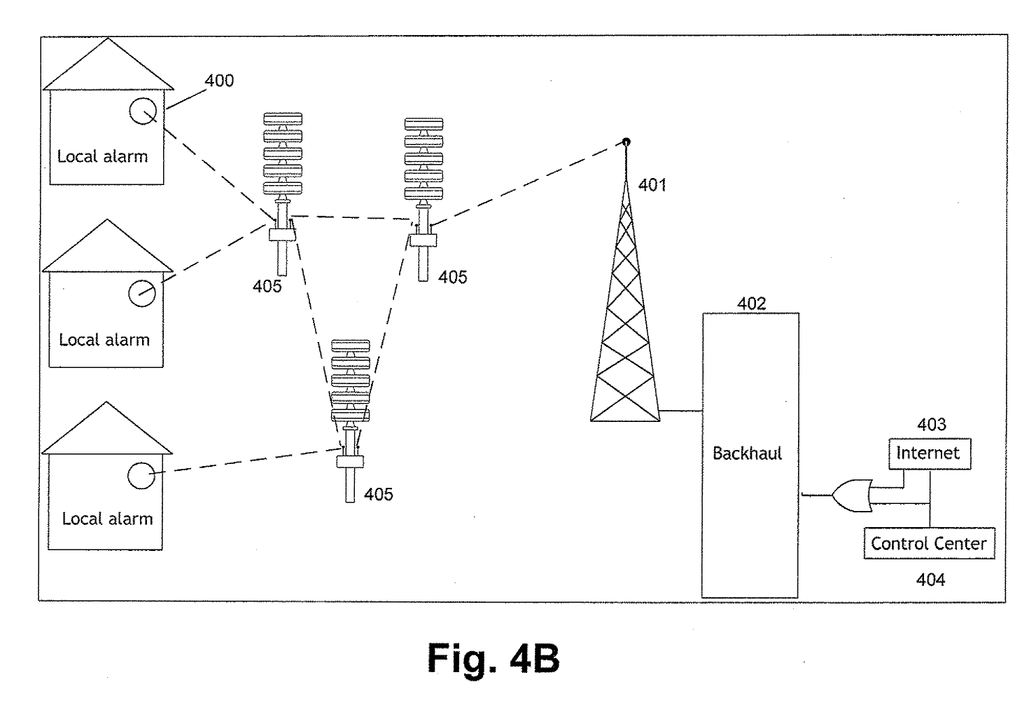

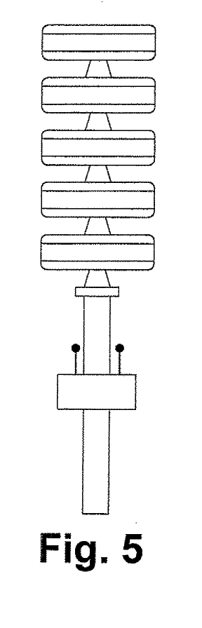

Numerous configurations of the network 203 are suitable for communicating with the smoke detector 304. For example, a point-to-multipoint network in FIG. 4A connects to alarm devices, such as smoke detectors 400. A tower 401 connects to each of the smoke detectors 400 configured with a network adapter. The standard for connecting the tower 401 to the smoke detectors 400 may be Wi-Fi or any other suitable wireless standard. The tower 401 then connects to the backhaul 402, which provides access to the Internet 403. The smoke detector is activated from the control center 404 over the network in response to possible disasters. In addition to controlling alarms, such as smoke detectors configured with network adapters, the control center may activate a number of devices in response to an emergency including community sirens, as depicted in FIG. 5. The control center 404 may also connect directly to the backhaul 402 without connecting thru the Internet 403.

FIG. 4B depicts another embodiment of the invention and illustrates a point-to-multipoint network connected to community sirens 405. Any appropriate wireless protocol may be used by embodiments of the invention. In this embodiment the community sirens 405 act as Wi-Fi nodes to form a community Wi-Fi mesh network. Thereby, each of the smoke detectors 400 connects to the Wi-Fi mesh network created by the community sirens 405. The community sirens 405 connect to the tower 401, which in turn connects to the backhaul 402. The control center 404 either connects directly to the tower 401, connects to the backhaul 402 or connects to the Internet 403 which is connected to the backhaul 402.

Network enabled alarms are not limited to connecting to a WAN thru the use of a municipal Wi-Fi network. Alarms, such as smoke detectors can be configured with many other types of wireless adapters for connecting to a WAN. In some embodiments of the invention a smoke detector is configured with a network adapter allowing the smoke detector to connect to cellular telephone and data networks. Examples of appropriate cellular telephone and data networks include:

| | | Theoretical | | Common | |
|---|---|---|---|---|---|
| Standard | Type | Speed | | Frequencies | Encoding Scheme |
| AMPS | Cellular | N/A | | 800 MHz band | Frequency-division multiple access |
| D-AMPS | Cellular | 48.6 | Kb | 800 MHz band | Time division multiple access |
| CDMA | Cellular | 14.4 | Kbps; | 800 MHz band | Code division multiple access |
| | | 115 | Kbps | 1900 MHz band | |
| EV-DO | Cellular | 2.4576 | Mb/s | 800 MHz band | Quadrature amplitude modulation |
| | | 3.1 | Mb/s | 1900 MHz band | |
| GSM | Cellular | Varies based | | 800 MHz band | Time division multiplexing |
| | | on data | | 850 MHz band | Gaussian minimum shift keying modulation |
| | | encoding | | 1800 MHz band | |
| | | scheme | | 1900 MHz band | |
| GPRS | Cellular | 160.0 | Kbit/s | Based on GSM | Based on GSM; Varies |
| EDGE | Cellular | 236.8 | Kbit/s | Based on GSM | Based on GSM; Varies |
| UMTS | Cellular | 1920 | Kbit/s | Based on GSM | Wideband Code Division Multiple Access |
| HSDPA | Cellular | 14.4 | Mbit/s | Based on GSM | Adaptive Modulation and Coding |

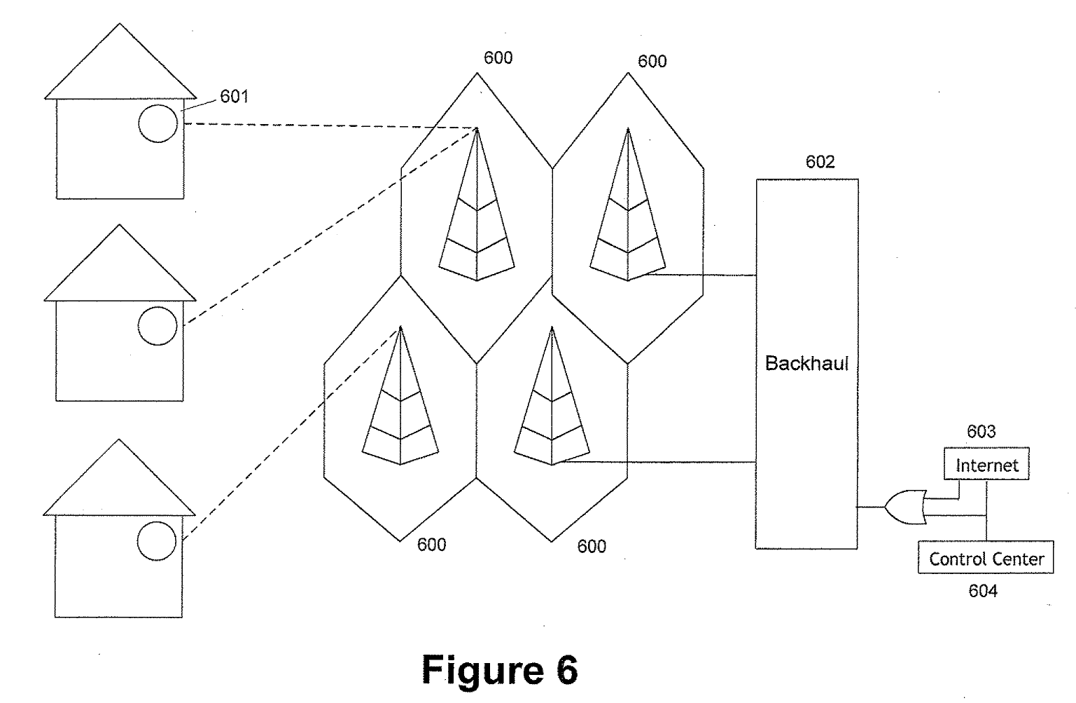

The example cellular networks are given for illustrative purposes. Embodiments of the invention can be configured with an appropriate network adapter for accessing cellular networks utilizing standards not specifically listed. FIG. 6 illustrates a typical cellular data network, using for example the EV-DO standard. The cell sites 600 connect to data devices such as a smoke detector 601 configured with a network adapter capable of accessing EV-DO networks. The cell sites 600 also connect to the backhaul 602, which provide access to the Internet 603. The smoke detector sends and receives messages from the control center 604 over the EV-DO network in response to possible disasters. Additionally, the control center 604 may be connected directly to the backhaul 602 or may connect wirelessly to the EV-DO network.

In addition to Wi-Fi and cellular connections, embodiments of the invention can utilize any appropriate wireless WAN. For example, Zigbee networks based on IEEE 802.15, the pager Mobitex network, the amateur radio AX.25 protocol, the Radio Broadcast Data System (RBDS) and other networks capable of transmitting data wirelessly may be used. Additionally, a municipality or private entity may configure proprietary networks to communicate with alarms. Although some embodiments of the invention require networks capable of two-way transmission, such that an alarm can both receive warnings issued by appropriate agencies and transmit local information to appropriate authorities, other embodiments of the invention require only one-way communication, such that an alarm receives warnings issued by appropriate agencies or entities. Such warnings are transmitted over a public network, such as the Internet or over a proprietary network or over a combination of public and private networks.

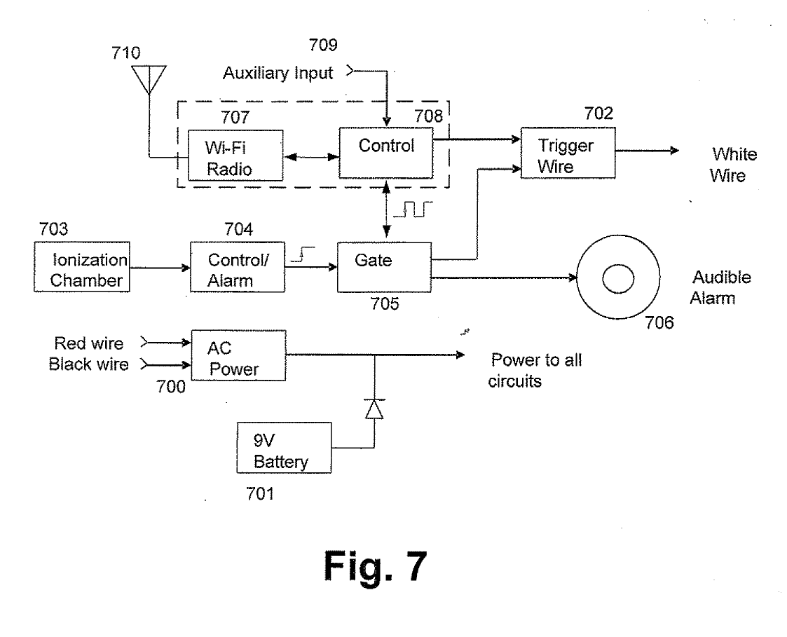

Any device configured with a network adapter may be used as the alarm. FIG. 7 depicts one embodiment of the invention and illustrates a smoke detector containing a Wi-Fi device. Today many residential and commercial dwellings are configured with smoke detectors. Typically, these smoke detectors are powered by two-wire 120 VAC power 700 with a 9V battery backup 701. The devices may also include a third wire 702 that allows all smoke detectors in a building to be “tripped” when one or more of the smoke detectors goes into alarm. The ionization chamber 703 triggers an alarm by detecting the presence of smoke. The control/alarm 704 monitors the ionization chamber 703 and connects thru a gate 705 to the trigger wire 702 and the audible alarm 706. The smoke detector illustrated in FIG. 7 also contains a Wi-Fi transceiver 707 connected to an antenna 710. The Wi-Fi transceiver interfaces with the audible alarm 706 and trigger wire 702 thru control logic 708. The control logic 708 receives signals from the transceiver 707 and decodes those signals in order to determine if the audible alarm 706 should be enabled via gate 705. In addition, the control logic 708 also sends a signal via the trigger wire 702 to other smoke detectors wired in the system. The control logic 708 can be a field programmable gate array (“FPGA”), or a microprocessor configured to interface with the Wi-Fi transceiver 707. Alternatively, the control logic 708 and the Wi-Fi transceiver 707 are combined into a computer on module such as the Compulab CM-X270.

Embodiments of the invention interface local control, monitoring and response systems with alarms containing a network adapter. For example, a home's local security system interfaces with a smoke detector containing a network adapter to send an alarm to the control center during a home invasion. The alarm system interfaces with the smoke detector thru an auxiliary input 709, which may be configured in various ways. For example, the auxiliary input may be a simple analog or digital signal indicating an alarm state. In another embodiment, the auxiliary input provides an analog or digital connection capable of accepting status information to be transmitted over the Wi-Fi network. The auxiliary input may be wired or wireless. The auxiliary input may use industry standard protocols such as universal serial bus (USB) or Wi-Fi or a proprietary interface. Various monitoring, warning and alarm systems can be interfaced to the smoke detector. Thereby, the smoke detector uses its network adapter to broadcast relevant information concerning the auxiliary systems to an emergency operation center, monitoring center, homeowner, or others with a desire to monitor systems within the home.

In one embodiment, the alarms monitor themselves and broadcast relevant data to a control center. For example, a battery operated smoke detector configured with a network adapter can monitor its battery level and send relevant data back to a control center. Thru automated or manual means, the control center notifies the responsible party of the low battery signal. Thereby the smoke detector's battery is replaced in a timely manner and the smoke detector is kept in good working order.

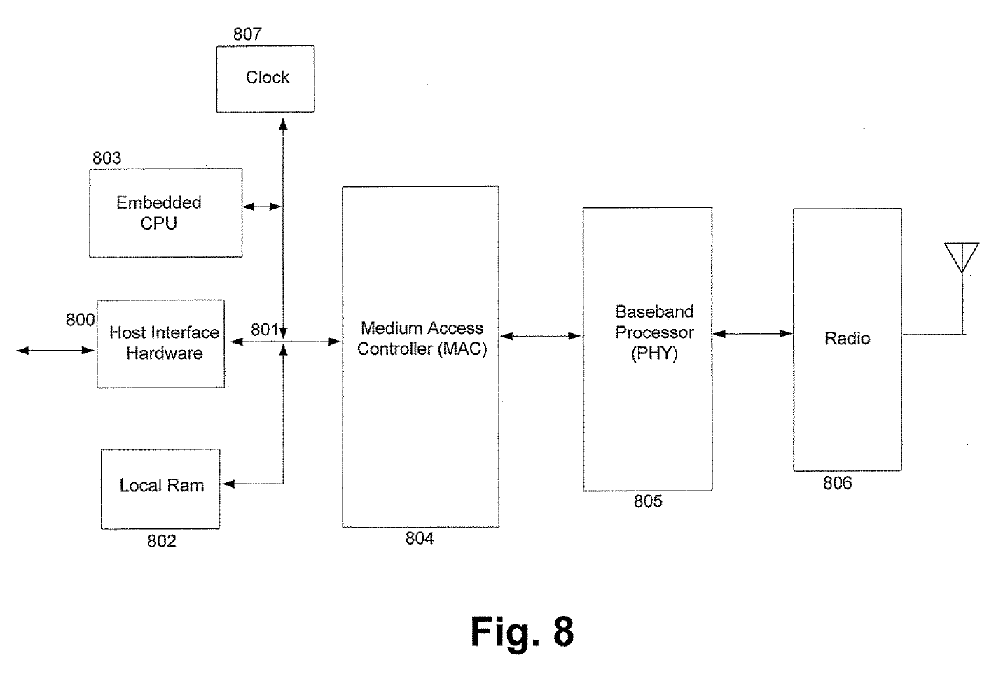

Any appropriate commercially available or proprietary network adapter is appropriate for use with the alarm. For example, FIG. 8 details one possible network adapter located in an alarm. In this embodiment of the invention a Wi-Fi transceiver is located within a smoke detector. The host interface hardware 800 connects to the control logic 708 in the smoke detector. This interface can be either a standard interface such as universal serial bus (USB) or a propriety interface. Thus, the transceiver communicates with the smoke detector thru the host interface 800 and the control logic 708. The host interface 800 also connects to a bus 801. The bus 801 provides the host interface 800 with access to local internal ram 802, an embedded central processing unit (CPU) 803 and the medium access controller (MAC) 804. The MAC provides the data link layer for connectivity to the network. It sends and receives requests from the physical layer (PHY) 805. The PHY may include an integrated baseband processor. The PHY 805 connects to the radio 806, which transmits and receives wireless signals. A clock 807 controls the radio transceiver. Any suitable radio transceiver may be used to provide network connectivity to the alarm.

The two-wire power 700 and trigger 702 configuration for smoke detectors, is a standard in the industry. Standard off the shelf replacement smoke detectors often include two additional wire harness adapters that allow the replacement smoke detector to be compatible with other manufacturer's devices wired into the system. The detectors are easy to replace by twisting the detector counter clockwise from the base, the smoke detector will drop down exposing the wiring harness that is plugged into the rear of the unit and the 9V battery 701 compartment. Homeowners can buy a replacement smoke detector that is network enabled, twist out any one of their existing smoke detectors, and replace it with the network-enabled smoke detector. The new network enabled smoke detector is wired into the existing smoke detector system within a building. Therefore, the smoke detection system in any residential or commercial dwelling can be converted to a network alarm system by simply removing any one smoke detector in the system and replacing it with a detector that is network enabled.

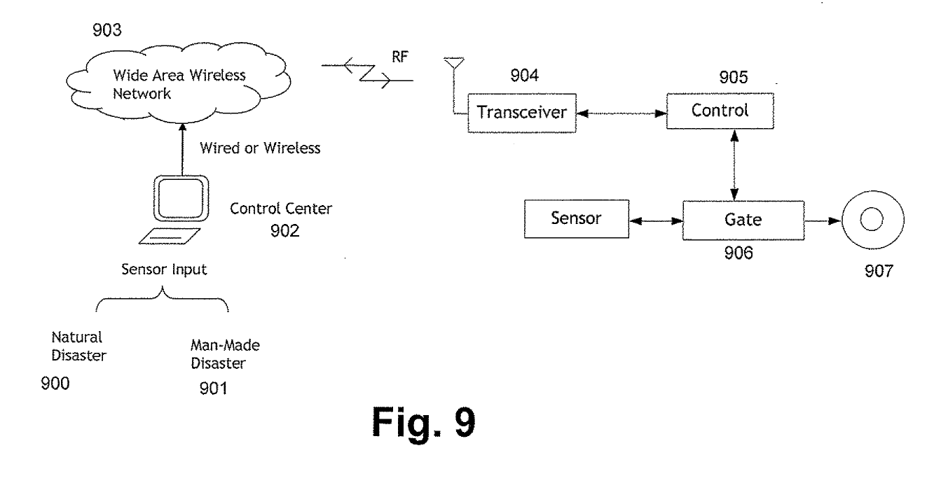

In one preferred embodiment of the invention, a smoke detector configured with a radio transceiver accesses a municipal Wi-Fi mesh network, which provides a connection to the Internet. FIG. 9 illustrates one possible flow of operation from a control center to activation of a local alarm. When a natural disaster 900 or man-made disaster 901 is immanent or has occurred the control center 902 receives information relating to the disaster. Through either automated or manual means, the control center 902 sends warning information through the wide area wireless network 903. The network 903 forwards this warning information to the smoke detector based on the smoke detector's physical location and proximity to the disaster. Various methods of determining the physical location of the alarm are contemplated. For example, the physical location of the smoke detector may be determined by matching a unique identifier, such as an IP address or a MAC address to a physical street address. Other suitable means of determining the physical location of the smoke detector include polling the smoke detector and the detector returning its physical location. The smoke detector's transceiver 904 receives the warning information. The transceiver 904 notifies the control logic 905 of the alarm signal. The control logic 905 sends a signal to the gate 906 and the gate 906 sounds an appropriate alarm or message using the device's audible annunciator or speaker 907.

The smoke detector may pulse the audible alarm in such a way as to indicate the type of emergency and to differentiate the hazard signal from the conventional smoke detector's signals. Alternatively, the smoke detector may play a pre-recorded audio message or a message broadcast from the control center 902. Occupants of the building are thereby warned of an impending disaster, such as severe weather.

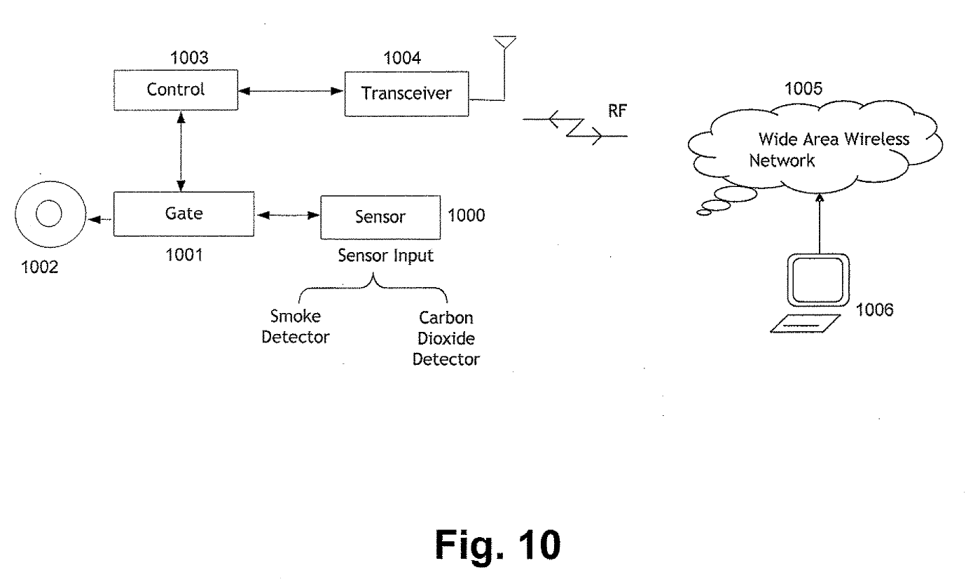

For some embodiments of the alarms, the presence of predetermined local conditions triggers a local alarm. The local alarm state is transmitted to a control center using an alarm configured with a network adapter. For example, in FIG. 10 a smoke detector's sensor 1000 detects smoke. The sensor sends a signal to the gate 1001 and the gate 1001 sounds the alarm using the smoke detector's annunciator or speaker 1002 thereby warning occupants of the building of the presence of smoke. The sensor 1000 also notifies the control logic 1003 of the presence of smoke. The control logic 1003 uses the smoke detector's transceiver 1004 to interface with a wide area wireless network 1005. The transceiver 1004 sends a message through the network 1005 to the control center 1006. Based on the message, the control center determines the type of emergency and the location of the emergency. The control center can then dispatch firefighters or other appropriate first responders to the smoke detector's location.

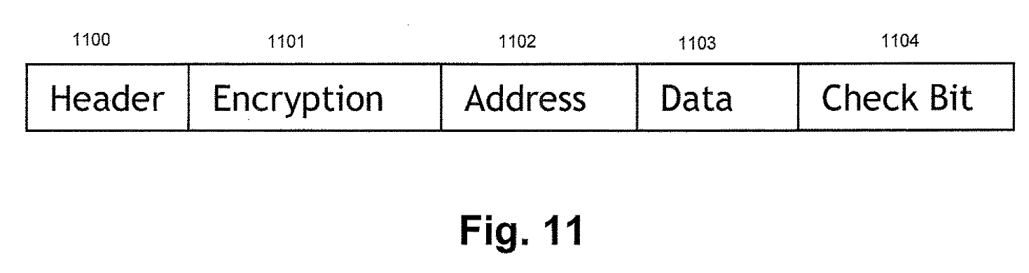

FIG. 11 illustrates one possible format for messages to and from an alarm. The header 1100 contains information indicating the beginning of a packet. The encryption section 1101 contains information related to the encryption of the packet. The address section 1102 may contain items such as the alarm's IP address and MAC address and the control center's IP address and MAC address. The data section 1103 contains the packet's payload. The payload may include the type of emergency, the location of the emergency, a broadcast message, or selection of a prerecorded message or tone. The payload also contains any additional data the situation requires. Finally, the check bit 1104 provides integrity of all data being sent.

Preferably, messages are sent individually over the network to alarm devices. However, messages may be sent to groups of alarm devices. For example, the address section 1102 of the message is an IP formatted address. The IP formatted address allows messages to be sent to individual devices or to groups of devices. For example, all devices sharing a common subnet can be grouped and receive broadcast messages sent to the subnet. Alternatively, other addressing formats having the same or similar functionality and variable granularity may be used to address individual or groups of alarm devices.

Alarm devices can also be configured with a network adapter for connecting to wired wide area networks. For example, cable television and telephone lines already provide network connectivity through digital subscriber lines (DSL), cable Internet, and dial-up network access. Alarms, such as a smoke detector can be configured with a network adapter for connecting directly to these and other wired wide area networks, thereby replacing the radio transceiver with a wired transceiver. The wired network may be a part of the Internet or may utilize a separate public or proprietary network.

In one embodiment, a network enabled alarm within a building is configured to connect to a local area network (LAN). The local area network connects to a wide area network (WAN), such as the Internet, through a gateway device. Examples of gateway devices include dedicated routers, switches and general-purpose computers configured to act as a gateway by providing connectivity from the LAN to the WAN. A large number of devices can be configured to act as a gateway. An alarm sends and receives messages from a control center thru the LAN connected to the WAN.

Alarms, such as a smoke detector, connect to a LAN through a number of different interfaces. An alarm can be configured to access a LAN through a Wi-Fi connection. Additional wireless protocols such as Wireless USB, Bluetooth or ZigBee connections, all based on IEEE 802.15, can be used. An appropriately configured alarm can also utilize a propriety means of wirelessly connecting to a LAN.

The gateway device connects the LAN to a WAN. In one embodiment the WAN is the Internet. The gateway device connects to a modem for accessing the Internet. Typical access methods for residences include dedicated subscriber lines (DSL), cable Internet access and dial-up access using the telephone network, Each of these methods requires a modem, which can be physically separate or integrated into the gateway device.

The gateway device can also connect the LAN to the WAN by utilizing a wireless link to the WAN. In one embodiment, an alarm connects to a gateway by way of a Wi-Fi connection. The gateway then connects to the WAN through a second wireless connection. The second wireless connection may utilize a cellular network or some other wide area wireless network such as a WiMax network or municipal Wi-Fi network. WiMax networks may be based on the Wireless MAN specification as defined in IEEE 802.16.

In addition to connecting wirelessly to the LAN, alarms can be configured to connect to a LAN through a wired connection. For example, many LAN connections are made through wired Ethernet based on the IEEE 802.3 specification. Other possible LAN standards such as token ring, FDDI, and ARCNET may be used to connect alarm to the LAN.

In another embodiment, an alarm such as a smoke detector is configured with a network adapter for accessing a LAN based on the 10BASE-T implementation of Ethernet as defined in the IEEE 802.3i specification. The LAN connects directly to a router acting as a residential gateway for accessing the Internet through a DSL connection established by means of a DSL modem. Based on community sensors or storm spotters, warning information due to severe weather is transmitted from a control center, through the Internet. The residential gateway forwards this warning information from the Internet to the LAN, where the smoke detector receives it. The smoke detector pulses the audible alarm in such a way as to indicate severe weather and to differentiate the hazard signal from the conventional smoke detector's signals. Occupants of the house are thereby warned of impending severe weather.

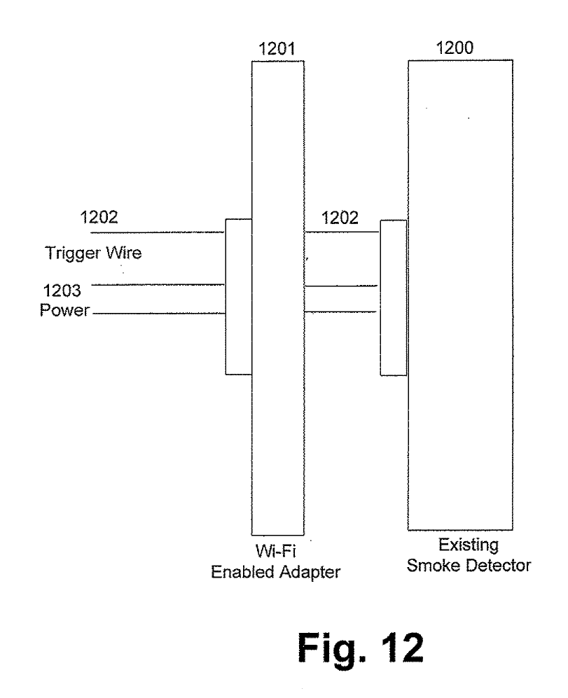

In addition to replacing a device, such as replacing a smoke detector with a network enabled smoke detector, some devices can be retrofitted into network enabled alarms. For example, FIG. 12 illustrates a conventional smoke detector 1200 retrofitted with a Wi-Fi adapter 1201. The Wi-Fi adapter 1201 is wired into the smoke detector's trigger wire 1202 and power connection 1203. When the Wi-Fi adapter receives a signal from a control center indicating an emergency, the detector sounds the alarm by asserting the trigger wire. The Wi-Fi adapter varies the audible alarm by asserting and de-asserting the trigger wire. Additionally, if the smoke detector asserts the trigger wire, indicating the presence of smoke, the Wi-Fi adapter sends a message to the appropriate authorities notifying them of the smoke detector's alarm. Although this embodiment shows a Wi-Fi adapter being used to retrofit the smoke detector, any appropriate network adapter may be used.

The alarm device may be both mobile and stationary. For example, the device may be easily carried by a person so that the person is alerted of dangerous conditions while outside of a building and while traveling. For example, a cellular telephone may be configured as an alarm device. The cellular telephone makes voice and data connections to the cellular network using standards such as CDMA and EV-DO. If the cellular telephone is registered as an alarm device, the system will track the device's physical location by, for example, monitoring the cellular tower the phone connects through.

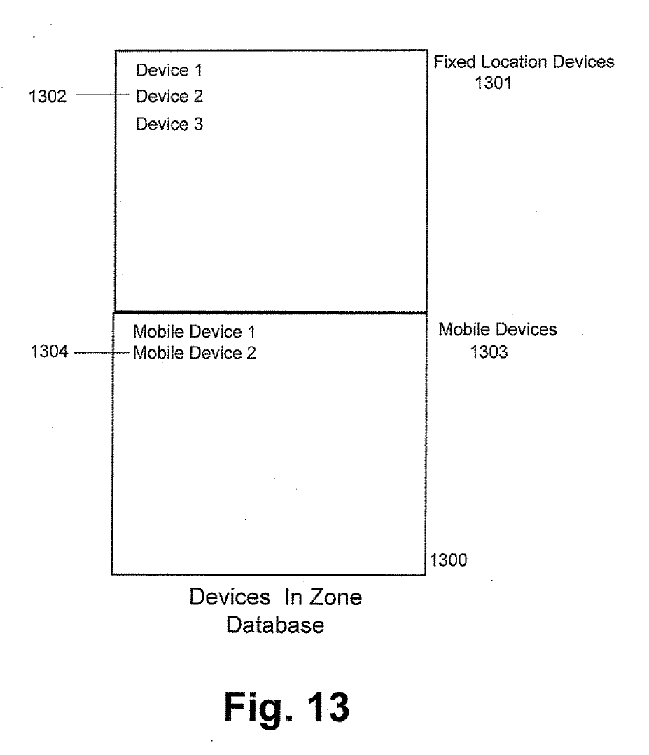

FIG. 13 illustrates one example of how the system is configured to track mobile alarms, such as cellular telephones. A database 1300 tracks alarms within a particular zone. For example, a zone could be all devices connected to a particular tower in a cellular network or all devices connected to any tower within a particular city. The database 1300 tracks all devices with a fixed position in a fixed location devices field 1301 of the database. For example, device 2 1302 can be a smoke detector configured with a network adapter. The system is configured such that device 2 is placed in the fixed location devices field 1301. Device 2 1302 then remains in the database for that zone. If the device is no longer being used within the zone, an operator can manually remove the device 1302 from the database 1300.

In one embodiment, the database 1300 also tracks mobile devices. For example, the database tracks a cellular telephone used with the system to provide alerts of emergency conditions. The database 1300 tracks mobile devices in the mobile devices field 1303. A mobile device 1304 is inserted into the database 1300 when it enters the zone for which the database 1300 has been programmed to track. When a warning is issued, all devices within the zone receive a message. The system checks the database 1300 for all fixed location and mobile devices currently within the zone. All devices receiving the warning messages then alert nearby citizens. For example, a smoke detector will beep in a particular manner. A cellular telephone may ring in a particular manner and display a textual warning on its screen.

There are many implementations for tracking devices within a zone. Some examples include the system periodically polling devices for their locations. Devices may utilize the global positioning system to determine position. The location of fixed devices can be preprogrammed into the system. The node the device is connected through may determine the location of mobile devices. Embodiments of the invention use any appropriate means of tracking devices within a geographic area.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of this description and especially in the context of the following claims are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for alerting a community, the system comprising;
a community-wide network;
a node in the network for individually addressing signaling devices connected to the network in response to an emergency condition in a predetermined geographic area; and
each signaling device located in a controlled environment and including a decoder for triggering a signaling generator of the device when an address from the node matches an address assigned to the signaling device.

2. The system of claim 1 wherein the signaling device is a smoke detector.

3. The system of claim 1 wherein the controlled environment is a building and the signaling device in the building includes a transmitter for transmitting a signal to a node in the community-wide network for alerting a public safety resource to a dangerous condition at the building.

4. The system of claim 3 wherein the signaling device is a smoke detector.

5. The system of claim 1 wherein the community-wide network includes a plurality of interconnected nodes of repeaters forming a mesh network for passing transmissions among the nodes to a destination signaling device whose address matched the address in the transmission.

6. The system of claim 5 wherein the mesh network is one of a Wi-Fi mesh network and a ZigBee mesh network.

7. The system of claim 1 wherein the community-wide network is one of a WiMAX system and a cellular network.

8. The system of claim 1 including signaling devices mounted in uncontrolled environments for generating alarms for alerting a general populace of the community.

9. The system of claim 1 wherein the community-wide network is a wireless network that connects to the Internet.

10. A detector and alarm for a building comprising;
a sensor for detecting a dangerous condition local to the building;
a receiver for receiving a signal including data indicating a dangerous condition outside of the building;
a decoder for comparing the data in the signal to expected data and generating a trigger signal when the comparison indicates a match; and
an annunciator responsive to (1) the sensor for generating a first audible signal for signaling the local dangerous condition has been detected and (2) the trigger signal for generating a second audible signal for signaling a dangerous condition outside of the building.

11. The detector and alarm of claim 10 wherein the receiver is one of a Wi-Fi receiver, a WiMAX receiver, a cellular receiver, an Ethernet receiver and a ZigBee receiver and the signal is one of a Wi-Fi signal from a Wi-Fi mesh network, a WiMAX signal, a cellular signal from a cellular network, an Ethernet signal and a ZigBee signal from a ZigBee mesh network.

12. The detector and alarm of claim 10 including a transmitter triggered in response to detection of the local dangerous condition by the sensor and a Wi-Fi signal generated by the transmitter including an address of a destination in a network.

13. The detector and alarm of claim 10 wherein the sensor is one of a smoke detector and a carbon dioxide detector.

14. The detector and alarm of claim 10 including a pluggable port for receiving an encapsulated unit including the receiver.

15. A method of alerting a community to a dangerous condition:
sensing the dangerous condition outside a controlled environment within a community of controlled environments connected to a communications network;
transmitting over the network a signal whose format allows for one of the controlled environments to be addressed; and
triggering an alarm at the controlled environment within the community of controlled environments when the signal is determined to be addressing the controlled environment.

16. The method of claim 15 wherein the format of the signal has the ability to alternatively address individual ones of the controlled environments or predetermined groupings of the controlled environments.

17. The method of claim 15 wherein the alarm is a first alarm and the method includes detecting a dangerous condition within the controlled environment and triggering a second alarm.

18. The method of claim 17 wherein the first and second alarms are recognized by occupants of the controlled environment to warn of different conditions.

19. The method of claim 15 wherein the network for transmitting the signal includes is one of a Wi-Fi network, a cellular network, an Ethernet network and a ZigBee network

20. The method of claim 15 wherein the network is a wireless network.

21. The method of claim 15 wherein the dangerous condition is severe weather.

22. The method of claim 15 including determining whether controlled environments within the network are exposed to the dangerous condition.

23. A method of alerting a community to a community-wide dangerous condition, sensing the dangerous condition;
transmitting a signal with data indicating the existence of the dangerous condition;
receiving the signal at a mobile signaling device located in a predetermined geographic area;
comparing the data in the signal to expected data for indicating the presence of a dangerous condition in the community; and
triggering an alarm when the data in the received signal matches the expected data.

24. The method of claim 23 including detecting a dangerous condition within a building and triggering an alarm.

25. The method of claim 24 wherein the alarm signaling the community-wide dangerous condition is different from the alarm signaling a dangerous condition within the building.

26. The method of claim 23 wherein transmitting the signal includes routing the signal to the signaling device over one of a Wi-Fi network, a cellular network, an Ethernet network and a ZigBee network.

27. The method of claim 23 wherein the signal is compatible for transmission over a wireless network.

28. The method of claim 23 wherein the community-wide dangerous condition is severe weather.

29. The method of claim 23 including determining if a signaling device is located in a predetermined geographic area.
